(19) United States
(12) Patent Application Publication
(10) Pub. No.: US 2023/0229768 A1
(43) Pub. Date: Jul. 20, 2023

(54) Apparatus and Method for Blocking Malicious Code Embedded in Digital Data

(71) Applicant: James Paul Stewart Snyder, Lexington, KY (US)

(72) Inventor: James Paul Stewart Snyder, Lexington, KY (US)

(21) Appl. No.: 18/097,321

(22) Filed: Jan. 16, 2023

Related U.S. Application Data
(60) Provisional application No. 63/266,861, filed on Jan. 17, 2022.

(51) Int. Cl. G06F 21/56; G06V 10/74

(52) U.S. Cl. CPC G06F 21/563; G06V 10/74; G06F 2221/033

(57) ABSTRACT

The present invention is a device, system, and method for improving network security using pictorial communication and in preferred embodiments optical character recognition for the communication of digital information so as to block malicious code embedded in digital data. More specifically, the present invention in preferred embodiments receives a digital data stream from an open network; identifies and extracts desired digital content from the digital data stream; deletes all remaining digital data; displays the extracted digital content as an pictorial image containing alphanumeric or other characters on one side of an analog air gap; captures the pictorial image on the opposite side of the air gap in a closed network; converts the pictorial image to a digital image file; uses optical character recognition algorithms to recognize and convert the pictorial image into a clean digital content file; and stores a copy of the clean digital content file in the closed network.

### CROSS-REFERENCE TO RELATED APPLICATIONS

This application claims priority from U.S. Provisional Application Ser. No. 63/266,861, filed Jan. 17, 2022, the entire disclosure of which is incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records but reserves all other copyright rights whatsoever.

### FIELD OF THE INVENTION

Embodiments of the disclosure relate to the field of cybersecurity. The present invention relates generally to network security and the use of pictorial communication for the transmission of digital information to block malicious code embedded in digital data, and more particularly, but without limitation, to an apparatus and method for receiving a digital data stream from an open network source; identifying and extracting digital content from the data, such as personal and business information intended for use in commercial transactions; deletion of the remaining digital data stream; display of the extracted digital content as an image of pictorial characters and/or other pictorial information on a monitor or similar display apparatus located on one side of an air gap; capture on the opposite side of the air gap of the displayed pictorial image by an image sensor; conversion of the captured pictorial image to a digital image file in a closed network; parsing of the digital image file using optical character recognition algorithms for recognition and digital encoding of images of pictorial characters; and storage of the encoded pictorial characters and/or other pictorial information in a clean digital content file within a secure physically isolated data facility.

### BACKGROUND OF THE INVENTION

Digital data generally refers to information placed in a prescribed digital binary format that is transmitted, processed, and/or stored in accordance with suitable protocols, and that is accessible through a logical data structure. For example, but without limitation, digital data may consist of information in digital binary format containing medical records, financial ledgers, corporate documents, commercial transactions, legal instruments, personally identifiable information, and/or any other information which is capable of being represented and encoded in a digital format.

Digital data is transmitted between network devices in the form of digital data streams sent over public and private networks. The term “open network”, as used herein designates a network which has limited security measures, for example the internet. The term “closed network” as used herein, describes a network which implements more stringent security measures and limits access to privileged users, like a private network used by a financial institution.

Digital data may be described as consisting of two components. The first component, “digital content”, as used herein, consists of digitized information which may be used for business, personal, and/or other purposes and which is intended and/or considered to be useful and not harmful by the individuals and/or entities which create, utilize, and/or are otherwise authorized to access the digital information. Digital content may include, but is not limited to, digital representations of information using characters, words, sentences, numbers, symbols, drawings, photographs, and/or other objects capable of digital binary encoding. The stored text of an electronic book is one example of “digital content”.

The second component of digital data, “digital code”, as used herein, consists of digital binary data into which digital content may be embedded and which serves as a formatting framework, medium for transport, instruction set, and/or other utilitarian purpose for the transport, processing, use, and/or storage of the digital content. For example, but without limitation, the digital data which manages the storage of text in an electronic book reader is “digital code”.

Digital code may contain executable algorithms which cause a targeted device or method to perform behaviors when triggered in response to human interaction prompted by the digital code or initiated by other means. For example, but without limitation, entry of a password when logging into a computing device may trigger the execution of digital code which allows the user to interact with the device and view digital content.

Malicious digital code includes, but without limitation, malware, ransomware, denial of service attacks, and other digital code which when activated causes a targeted device or method to perform unauthorized, unexpected, anomalous, and/or unwanted malicious behaviors. The malicious behaviors may be conducted automatically, may be triggered in response to human interaction prompted by the malicious code, or initiated by other means. Malicious code may be inserted into a digital data stream at any point from creation of the digital data to the archival storage or deletion of that data. Digital code, as used herein, may include malicious code which causes malicious behaviors, digital content cannot cause malicious behaviors in the absence of malicious digital code.

The term “embedded”, as used herein, is intended to convey in the broadest sense the presence of separate, distinguishable, digital objects as components of digital data. For example, but without limitation, digital content may be embedded in digital code which acts as a transport layer for the digital content, however the digital content remains a separable digital object which may be extracted from the digital code. The term “digital processor”, as used herein, describes a programmable computational device consisting of electronic circuitry that executes instructions in the form of digital code, such as a central processing unit in a computer. The term “digital filter”, as used herein, designates a digital processor device capable of recognition and extraction of digital objects embedded within other digital objects, for example recognition and extraction of digital content embedded in a digital data stream.

The term “pictorial image”, as used herein, designates a visual representation of digital content, such as the alphanumeric text displayed on a computer monitor which is viewed as an analog visual object by the human eye. The term “pictorial character”, as used herein, designates the selection of a pictorial object as an element of a pictorial image for the purpose of communicating digital content, for example the letter A when viewed on a display device as the visual object A. The term “defined pictorial character”, as used herein, designates the definition and/or creation of a pictorial object for the purpose of communicating digital content, for example a single character defined as representing a word. The term “pictorial information”, as used herein, is digital content in pictorial form which is not suitable or capable of conversion into pictorial characters, such as illustrations, photos, and handwriting. To accurately disclose the present invention, the image of a pictorial character and/or pictorial information when displayed on an analog monitor (one example, a CRT screen) or on a digital monitor (one example, an LCD screen) is referred to herein as an “analog pictorial image”.

The term “digital air gap”, as used herein, designates an air gap across which information in the form of digital data is transmitted in one direction only from a sending device to a receiving device, for example an air gap where a digital data stream is transmitted utilizing digital diodes. The term “analog air gap”, as used herein, designates an air gap across which information in the form of a pictorial image is communicated in one direction only from a sending device to a receiving device and where the information is not transmitted as digital data, for example an air gap where a pictorial image is displayed on a monitor on the sending side and captured by an optical lens and camera on the receiving side of the air gap.

The term “communication”, as used herein, describes the transport of information across an air gap in the form of a pictorial image. The term “transmission”, as used herein, describes the binary transport of information across an air gap in the form of digital data. The term “obfuscation”, as used herein, should be understood to include all methods used to avoid or hinder recognition of malicious code, including but not limited to steganography.

The term “digital image files”, as used herein, describes digital data files which encode pictorial images of characters and/or other pictorial information captured by analog and/or digital image sensors; retain their format as pictorial images; and are stored in a digital image format (one example, the .png portable network graphics format), for example a photograph stored on a digital camera memory card. The term “clean content”, as used herein, describes digital information obtained from analog pictorial characters when converted into digital data by the application of optical character recognition algorithms. The term “clean content file”, as used herein, describes a digital file containing clean content.

Current cybersecurity devices and methods are designed to recognize and extract malicious code embedded within a digital object, for example ransomware embedded in a digital data file, electronic mail message, or web content. They typically extract malicious code by comparison of the digital bits and bytes within the data with known patterns of malicious code; deploying an analysis system in a virtual sandbox environment to conduct behavioral analyses on model targets; the use of artificial intelligence and machine learning algorithms to predict malicious behaviors from unknown threats; and/or other similar methods. If code suspected as being malicious is identified, it is extracted and quarantined in isolated sections of computer memory commonly referred to as sandboxes.

Existing devices and methods expend substantial computational resources searching for malicious code and consistently fail to detect cybercriminal exploits until after significant loss or damage has occurred. It is generally accepted by government and private experts that the detection and extraction of all known and unknown (zero day) malicious code is impossible, and that malicious code will continue to be surreptitiously inserted into digital data (see, https://www.cisa.gov).

Furthermore, the risk of denial of service attacks, as well as system and/or data corruption, remains high when a more secure closed network receives digital data from an open network. Bidirectional communication between a closed network and open network also increases the likelihood of sensitive data leaking from the closed network to the open network.

In recognition of the unabated risk of malicious code, cybersecurity devices and methods attempt to minimize the vulnerability of digital data to cyberthreats by reducing the exposure of the data to threat vectors. A preferred method of improving data protection is the one way transmission of digital information believed not to contain malicious code from an open network to a more secure closed network.

Closed networks are assumed to be less likely to experience security breaches than open networks. Existing cybersecurity devices and methods typically use one way data diodes or similar devices to allow data to travel in one direction only from an open network source into a more secure closed network, and from the closed network to a destination network. Data diodes operate somewhat like a telegram by sending unidirectional modulated light pulses across an air gap, and are the basic component of most existing prior art.

Prior art that provides or attempt to provide similar computer and/or network security includes: U.S. Pat. No. 8,646,094 to Staubly ('094 Patent), which discloses an apparatus for providing secure data transfer through system devices which include a one way data link; U.S. Pat. No. 8,831,222 to Menoher et al. ('222 Patent), which discloses a transmission system that includes bilateral unidirectional data transfer; U.S. Pat. No. 8,498,206 to Mraz ('206 Patent), which discloses system interface circuitry which is asserted to provide secure one way data transfer; U.S. Pat. No. 8,380,913 to Goldring ('913 Patent), which discloses a data diode device; U.S. Pat. No. 8,068,415 Mraz ('415 Patent), which discloses network interface circuitry that restricts which network components can send and receive data; U.S. Pat. No. 8,250,235 to Harvey et al. ('235 Patent), which discloses a method and system for one way transfer of data with transmission of a data receipt to the sending network; and U.S. Pat. No. 6,108,787 to Anderson et al. ('787 Patent), which discloses a method and means for interconnecting different security networks through use of a diode and a switch; U.S. Pat. No. 9,967,234 to Crane et al., (Crane or '234 Patent) which discloses a device and method to secure live full motion video with metadata; U.S. Pat. No. 10,530,748 to Retvold et al. ('748 Patent) which discloses a fiber optic method for transmitting optical signals; U.S. App. Pub. No. 2020/0336808A to Menoher, which discloses a fiber optic method for transmitting optical signals using artificial intelligence and a one way data flow device.

Digital data files that include digital content are capable of including malicious code. Obfuscation and advanced steganography techniques may be employed to prevent the detection of the malicious code. A simple example illustrates the superiority of the present invention, a data stream might include two consecutive 8 bit bytes, 01000001 and 01111111. The first byte may be interpreted by a digital processor as a valid ASCII digital code for the capital letter A. The second byte 01111111 is a valid delete character in the ASCII character set (Char #127). However, the same character #127 also encodes a dark blue color (RGB hex #00007f) when interpreted as component of a digital image and a jump opcode (JNLE) in the Intel 8086 processor instruction set when interpreted as an executable program.

Firewalls, and other devices and methods currently used to prevent malicious behaviors, attempt to recognize malicious code and quarantine it so that the code is not transmitted in a digital data stream. Firewalls apply rule sets to recognize and detect malware. The National Institute of Standards and Technology (NIST) notes that rule sets need to be frequently reviewed to provide adequate protection in light of ever changing security threats. Whether or not the second byte in the example (01111111) would be detected as a processor instruction in a possible malicious code sequence or would be allowed to cross an air gap as a valid ASCII and/or RGB value, depends on the malware detection algorithms and rules applied by the firewall. Assuming that the second byte is a jump opcode in a string of malicious code, it will be transmitted from the open network to the closed network if the firewall wrongly interprets it as an encoded RGB dark blue color.

To remove malware firewalls and other malware detection algorithms must detect malicious code, because malicious code threat vectors are constantly changing, the possibility always exists that they may allow transmission of obfuscated known malicious code or unknown (zero day) malware into a more secure network. As a result of the impossibility of detection and extraction of all known and unknown malicious digital code, current methods of transfer of digital data from open to closed networks cannot eliminate risk of transmission into the closed network of undetected malicious code embedded in digital data. The present invention is superior to all existing devices and methods in that it identifies and extracts digital content and deletes all other digital code, blocking cyberthreats without requiring recognition and identification of malicious code.

On first consideration it would seem that detecting and removing malicious code from a digital image, displaying the digital image, and capturing it on a camera, would be as secure as extracting and displaying the digital content in a data stream, but this is not the case. A still or video digital image consists of digital code which can manipulate pixels on a digital monitor in addition to the pixels used to display digital content. For example, but without limitation, a QR code can be incorporated into a picture to appear as a harmless out of focus smudge. When captured by an image sensor the hidden QR code can inject malicious code into the closed network. While at present it is technologically unlikely that malware is being transmitted into secure closed networks by the capture of compromised images, it is theoretically possible, and therefore a reasonable threat exists that digital data containing malicious code hidden in digital images may be reconstructed inside a secure closed network.

The Crane '234 Patent purports to generate a clean video data stream by passing digital video images through a firewall on an open network module to identify and remove malicious code, before displaying and capturing the live digital images in a more secure module. The displayed images do not have as their source a data stream constructed from extracted digital content only. The live video displays the digital data stream after being parsed by the firewall and includes pixel patterns generated by any malicious code that was not detected. The Crane patent as disclosed represents a mobile digital live real time display device which has the limited functionality of applying antivirus algorithms to a data stream in real time to successfully, or unsuccessfully, detect and remove malware as part of the one way transfer from a less secure module to a more secure module for use in combat situations.

The present invention identifies and extracts digital content in a digital data stream received from an open network; deletes the remaining digital data which may contain malicious code; displays the extracted digital content as a pictorial image on a monitor or similar display apparatus located on one side of an air gap; captures the displayed pictorial image on the opposite side of the air gap; and converts the pictorial image to a clean digital content file in a closed network. None of the current devices and methods, include Crane, extract digital content, discard all remaining digital data, convert the digital content to a pictorial image, communicate the pictorial image across an analog air gap, and convert the captured pictorial image into a clean digital content file.

Conversion of digital content into a pictorial representation on the sending side of an analog air gap and capture of the pictorial representation on the receiving side allows clean content to pass across the analog air gap barrier, while blocking the passage of all digital code. Unlike existing air gap systems, the present invention provides no transport mechanism by which malicious code can cross the analog air gap from an open network into a closed network.

### SUMMARY OF THE INVENTION

Existing air gap devices and methods which transfer digital data from an open network to a closed network embed the digital content in digital code, which acts as a transport mechanism for the digital content across the air gap and/or verification of successful transmission (one example, but without limitation, use of bidirectional checksum comparison of data in the closed network and the open network). The transmission of digital code across a digital air gap introduces the risk of exposure to transmission of malicious code, denial of service attacks, system corruption, and/or data loss into the closed network.

The present invention takes a fundamentally different approach than current devices and methods, which must be capable of recognizing malicious code to prevent malicious behaviors. Instead of attempting to identify and extract malicious code from digital data, the present invention recognizes and extracts digital content; deletes the remaining digital data; displays a pictorial representation of the digital content on a display device on one side of an air gap; captures the pictorial image of the content on the opposite side of the air gap; and in the case of digital content which is capable of representation as alphanumeric or other pictorial characters, uses optical character recognition algorithms to convert the captured pictorial images to a digital clean content file in a secure closed network. Digital content which is not capable of representation as alphanumeric or other pictorial characters, such as illustrations, is captured by a separate digital processor device and stored as digital image files.

The digital content in business documents; personally identifiable information protected by HIPAA (the Health Insurance Portability and Accountability Act), GDPR (General Data Protection Regulation), and other governmental regulation; credit card PCI data; numerical transactional records; and other similar digital content is typically encoded as binary alphanumeric and/or other characters which may be extracted and converted into pictorial characters. Pictorial information in digital content, such as illustrations and pictures, may be included in a data stream to visually describe the digital content represented by pictorial characters. Such pictorial information in many cases may be duplicative and/or explanatory of the pictorial characters and may be deleted without negatively affecting the intended communication of the information in the source digital data stream.

In preferred embodiments of the present invention, source data is received from an open network and processed by a dedicated digital processing device executing algorithms which recognize digital content, such as human readable text in documents and numeric characters representing quantity or price in commercial transactions. With the prior consent of the individuals and/or entities providing the digital data stream, other forms of digital content, if any, are deleted with the remainder of the digital data stream. In some embodiments the algorithms may include artificial intelligence and machine learning code to improve recognition of digital content in the source digital data stream.

The extracted digital content is displayed by a dedicated digital processor device as a pictorial image on a dedicated display device located on one side of an analog air gap, for example a computer monitor, utilizing selected alphanumeric and/or other defined pictorial characters. For example, but without limitation, when a digital tablet is used as a book reader the image of a page of a book that is displayed is a pictorial representation of the page stored in the device's digital memory and is viewed by the reader's eyes as a visual pictorial image. In some embodiments the characters which are selected to pictorially represent the digital content are chosen based on knowledge of the nature of the digital content contained in the data stream. In some embodiments the display device may be physically capable of and/or programmed to display only the selected alphanumeric and/or other defined pictorial character set by physically and/or programmatically disabling pixels not necessary for the display of the character set.

The analog pictorial image of alphanumeric and/or other defined characters displayed on the sending display device is received and captured by a dedicated processor device containing an image sensor, located on the opposite side of the analog air gap, which is capable of recording pictorial images, for example an optical lens and image sensor similar to a digital camera. The digital processor device encodes the pixel patterns on the sending display in a similar manner as a photograph taken by a digital camera and may be physically capable of and/or programmed to capture only the selected alphanumeric and/or other defined pictorial character set. The analog pictorial image is converted to a digital image file (for example, a .png—portable network graphic file) for further processing. In some embodiments the analog to digital conversion device may be physically capable of and/or programmed to only convert from analog to digital the selected alphanumeric and/or other defined pictorial character set.

The digital image file is processed by the digital processor device to remove unwanted digital artifacts such as aliasing. The pictorial representation of digital content contained in the digital image file is parsed using optical character recognition algorithms to convert and encode the digital images as binary digital representations of the characters, which are recorded as clean digital content in a digital content file. In some embodiments the optical character recognition algorithms may utilize artificial intelligence and machine learning methods to improve the accuracy of the recognition and conversion of digital images and to warn of the possible use of anomalous content which could indicate the use of steganography to obfuscate malicious code. For example, but without limitation, an alphanumeric word might be flagged for review if it was nonsensical or had an unusually large number of characters.

In other embodiments, digital content which can be represented by pictorial characters is converted into pictorial characters; processed in the same manner as in the preferred embodiments; and stored as clean content files. Digital content which cannot be represented by pictorial characters is displayed as a pictorial image on the sending side of the analog air gap; captured as analog pictorial images on the receiving side; recorded as a digital image file; and stored along with an index linking and synchronizing the digital image file with any clean digital content files extracted from the same source digital data stream.

Furthermore, the present invention is superior to current devices and methods in the verification of accuracy of digital content transmitted and/or communicated across an air gap. Transmission of an alphanumeric character over a digital air gap is typically accomplished by current devices sending each encoded character as a serial transmission of between 8 and 32 digital bits. If significant bits representing the digital characters are not correctly sent and/or received, the receiving device misreads the characters. To verify correct transmission of a digital character sent across a digital air gap, such as a digital diode air gap, some form of algorithm must be employed, such as utilizing error correcting code, multiple transmission of the same character, and/or bidirectional communication. Existing verification methods reduce the transmission rate of digital data and/or introduce the risk of bidirectional transmission of malicious code and protected data between an open and closed network.

The present invention's error rate is superior to existing devices and methods. The analog nature of the pictorial characters provides parallel optical communication of multiple pixels comprising each character which may be captured by a sensor and accurately converted to digital content by optical character recognition algorithms even if a percentage of pixels or other data points comprising the character are missing or corrupt. Pictorial representation of characters and other digital content eliminates the need for bidirectional comparison and/or other verification of information crossing an air gap. The display and optical capture of pictorial images of digital content assures, with a statistical certainty exceeding existing methods, that digital content in the closed network is an identical copy of digital content received from the open network.

The present invention produces clean digital content which does not contain malicious code and/or other executable malicious code vectors. The clean content is protected and stored in a closed network, typically located within a secure digital data facility which is isolated from cyberthreat vectors. The present invention is superior in that it prevents transmission of malicious code, denial of service attacks, system corruption, data loss, and/or access to the clean digital content by cybercriminals, including access to protected personally identifiable information (PII) such as medical data protected under HIPAA statutes.

### BRIEF DESCRIPTION OF THE DRAWINGS

FIG. 1 illustrates a one way data communication system of digital content according to some embodiments for communicating data across an analog air gap from an open network to a closed network;

FIG. 2 illustrates a one way data communication system of digital content according to some embodiments for communicating data across a protected analog air gap into to a protected data facility from an open network to a closed network of FIG. 1;

FIG. 3 illustrates the use of two receiver devices on the closed network of the one way data communication system of FIG. 2;

FIG. 4 illustrates the use of two data displays on the sender device on the open network and two receiver devices on the closed network of the one way data communication system of FIG. 3;

FIG. 5 illustrates the use of two data displays on the sender device on the open network and two receiver devices and two digital diodes contained in separate areas on the closed network of the one way data communication system of FIG. 4;

FIG. 6 illustrates the use of two data displays on the sender device on the open network and two receiver devices and three digital diodes contained in two separate areas on the closed network of the one way data communication system of FIG. 4;

FIG. 7 illustrates a modular and/or mobile configuration for the one way data communication system of digital content according to some embodiments for communicating data, across a protected analog air gap from an open network to a closed network of FIG. 2;

FIG. 8 illustrates the one way data communication system of digital content according to some embodiments for communication and storage of data, across a protected analog air gap from an open network to a closed network of FIG. 2;

FIG. 9 illustrates a one way data communication system according to some embodiments for communicating digital content across an analog air gap from an open network to a SaaS database on the closed network of the one way data communication system of FIG. 2;

FIG. 10 illustrates a flow chart of a one way data communication system according to some embodiments for communicating digital content across an analog air gap from an open to a closed network of the one way data communication system of FIG. 2.

### DETAILED DESCRIPTION OF THE INVENTION

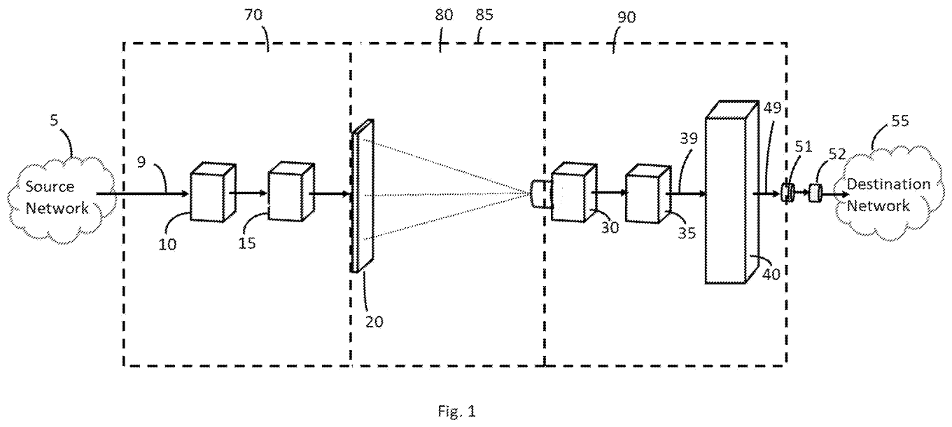

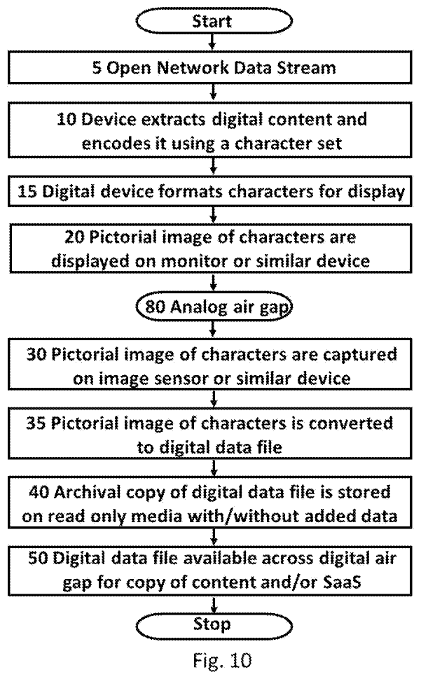

Referring initially to FIG. 1 and FIG. 10 chart, the present invention includes an apparatus and method which receives a digital data stream from an open network source 5 into a data preparation area 70; identifies and extracts digital content 9 embedded in the digital data stream utilizing the digital processor in digital filter device 10; blocks malicious digital code by deletion of the remaining digital data stream; converts the extracted digital content utilizing the digital processor in display driver device 15 into a pictorial image consisting of alphanumeric and/or other defined pictorial characters which is displayed on a display device 20 on one side of an analog air gap 80 enclosed in a protective sheath 85; captures the pictorial image on an image sensor device 30 located in a protected data facility 90; utilizes the digital processor in the image sensor device 30 to convert the pictorial character image into a digital image file in a closed network; utilizes optical character algorithms executed by the digital processor in the digital conversion device 35 to convert the captured pictorial image file into a clean content file 39; stores a read only archival reference copy of the clean content file 39 in a closed network storage device 40 in the protected data facility; and on request delivers copies of the archival reference copy across a one way digital air gap utilizing digital diodes 51 and 52 to a destination network 55. Whether specifically stated or not, the dedicated digital processor devices and other devices as described herein should be understood as being capable of, and programmed to, execute the methods and functions of the present invention, such as execution of optical character recognition algorithms.

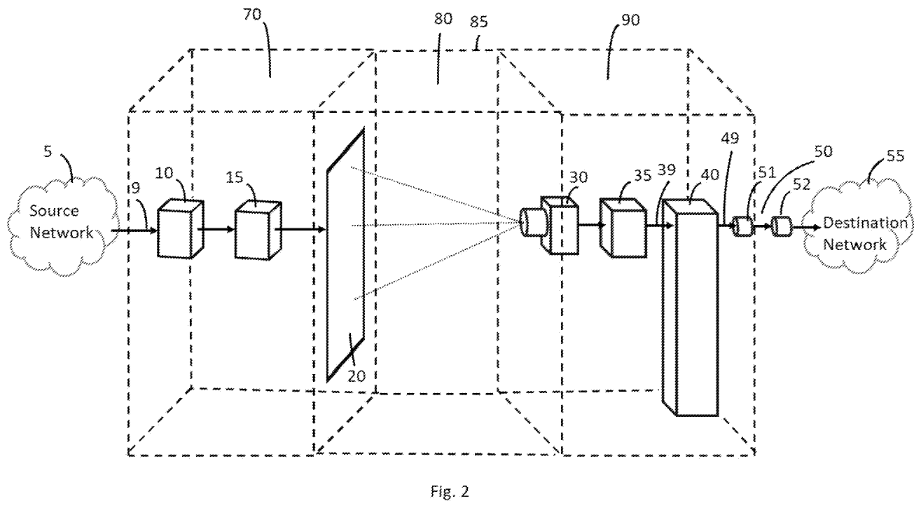

Referring to FIG. 2, in one preferred embodiment of the present invention digital data received from individuals, entities, customers, institutions, governmental units, and other sources is input as a digital data stream from open network 5. The source digital data stream is processed in a data preparation area 70 by parsing the digital data stream utilizing a digital processor in a dedicated digital filter device 10 programmed to recognize and identify digital content 9 embedded in the digital data stream which is capable of representation as pictorial characters. The digital content is extracted from the digital data stream and the remaining digital data stream is deleted by the digital filter device 10.

The digital content is converted into a pictorial character image consisting of alphanumeric characters and/or defined characters utilizing a dedicated digital processor in display driver device 15 programmed to execute digital conversion and display device driver algorithms. The pictorial character image is displayed on a display device 20, for example a computer monitor.

The display device 20 is attached to the external wall of the data preparation area 70 facing an image sensor device 30. The pictorial image of characters displayed on the sending display device 20 is communicated in a one way direction across the analog air gap 80 and captured on the image sensor device 30 which is located on the opposite side of the analog air gap. The dedicated image sensor device 30 consists of one or more optical lenses, one or more image sensors, and one or more dedicated digital processors (similar to a lens, image sensor, and digital processor in a digital photographic camera) configured and programmed to capture and convert the pictorial image on display device 20 into a digital image file 33, for example a portable network graphics (.png) file, for further processing in the digital conversion device 35. The dedicated digital processor in the image sensor device 30 may also be programmed to remove unintended and unwanted digital artifacts from the pictorial image, for example aliasing resulting from the capture of the displayed pictorial image.

The analog air gap 80 is enclosed in a protective barrier or sheath 85, designed to meet the same or higher security standards as the secure digital data facility 90 to prevent interception of information crossing the analog air gap or injection of malicious code between the display device 20 and image sensor device 30. The protective barrier 85 surrounding the analog air gap 80 is affixed to the outer wall of the data preparation area 70 and the outer wall of the secure protected data facility 90, and acts as a sheath enclosing the analog air gap 80 to isolate and protect both the display device 20, the one way communication path, and the image sensor device 30 from cyberthreats.

The dedicated image sensor device 30 is located within a secure protected data facility 90 which isolates and protects both the image sensor device and other devices inside the protected data facility 90 from cyberthreats. The image sensor device 30 captures the image through a protected opening in the outer wall of the secure data facility 90 which maintains the integrity and security of the secure data facility. The secure data facility may be designed to meet various levels of security standards up to or exceeding the security requirements of the United States Department of Defense for certification as a Sensitive Compartmented Information Facility (as prescribed in Intelligence Community Directive 705, 705-1, 705-2, and successor regulations).

The pictorial character images encoded in the digital image file 33 are processed by the dedicated digital processor in the digital conversion device 35 which is programmed to execute optical character recognition algorithms to convert the pictorial character images in the digital image file 33 into digital data in the clean content file 39.

The digital content contained in the clean content files 39 is an accurate unformatted copy of the information extracted from the digital content 9 in the source data 5 and is archived as a permanent reference copy in the closed network storage device 40 located within the secure protected digital data facility 90. The archival reference copy is recorded on encrypted write once read many (WORM) times magnetic tapes, optical discs, holographic media, and/or other storage media restricted to the one time recording and multiple reading of the digital data. At the request of an authorized individual or entity or entity a copy of the archival reference copy may be generated and transmitted across the digital air gap 50 to the requesting party through the destination network 55, however the reference copy is never altered or removed from the protected data facility 90.

In some embodiments of the present invention, to reduce aliasing frame rates may be chosen that are approximately the same for both display device 20 and image capture sensor device 30 and/or a sufficient delay between communication of images may be employed so that multiple display refresh and image sensor capture cycles may be recorded for each displayed pictorial image, with the digital processor within the image sensor device 30 and/or the digital conversion device 35 selecting the image containing the least number of unwanted digital artifacts and/or combining images to generate a composite image having the least number of unwanted digital artifacts. To increase throughput, continuous display and capture of multiple frames containing pictorial images (similar to stop motion photography) may be employed with the frames having the least number of unwanted digital artifacts selected by the image sensor device 30 and/or the digital conversion device 35 for further processing.

The digital conversion device 35 may add index and other digital code to the digital character strings which is useful in the storage, maintenance, and retrieval of the digital content, for example unique index values may be added identifying the open network source of the digital content.

The flow of all digital data received from open source networks 5, processed by the present invention, and sent to designation networks 55 outside the secure data facility is one way, unidirectional. In some embodiments of the present invention, a request for a copy of a clean content file 39 stored within the closed network storage device 40 is transmitted into the secure data facility 90 utilizing the same and/or similar one way apparatus and methods used to transmit pictorial character digital content into the secure protected data facility 90. The alphanumeric index value of the requested archived reference copy may be displayed on the display device 20, captured by the digital image sensor 30, and programmatically recognized by the digital conversion device 35 utilizing optical character recognition algorithms as a request to retrieve a copy of clean digital content with the matching alphanumeric index. A copy of the archival reference copy 49 of the clean content file 39 is retrieved from the closed network storage device 40 and sent across a unidirectional digital air gap 50 utilizing one way digital diodes 51 and 52 and/or similar devices to the authorized requesting party in the destination network 55. The methods and devices utilized to process a request for a copy of the stored clean content file enforce one way transmission of clean content and do not allow the transmission of digital data into the secure data facility 90.

Digital data diodes 51 and 52 and/or similar devices enforce one way data flow and are used as the only method of transmission of information from inside the secure protected data facility 90 across an out bound digital air gap to the destination network 55 outside the facility. To maintain unidirectional data flow, transmission of data is accomplished utilizing devices and methods which do not require bidirectional exchange of timing or other digital information. For example, but without limitation, digital diodes 51 and 52 (and as described in other embodiments digital diodes 53 and 54) are designed to transmit unidirectional data flow by operating in a standby mode, with the receiving diode 52 waking on detection of output from the sending diode 51. Timing may be synchronized by the digital diode receiving unit 52 monitoring a one way signal (such as activation of a red light) from the digital diode sending unit 51 which is not capable of transmitting digital data. There is no transmission of data or other digital signals from a digital diode and/or other device outside the secure data facility 90 (and as described in other embodiments the secure data area 91) to a digital diode and/or other device inside the secure protected data facility 90.

In some embodiments of the present invention, the digital processors and sensors utilized in devices 10, 15, 30, and 35 may be physically and/or programmatically restricted to the recognition and processing of pictorial character sets selected for communication of digital content, and rendered incapable of any other recognition and processing. For example, but without limitation, the digital content may be processed by the display driver device 15 capable of displaying the selected pictorial character set on a monitor or other similar display device 20 and rendered physically or programmatically incapable of displaying other information. This may be accomplished by the digital processor in the display driver device 15 being programmed to activate only those pixels necessary to display the selected pictorial character set and to reject the activation of any other display pixels, and/or the display pixels may be physically disabled in the display device 20 circuitry and/or the physical components of the display device. For further example, specific pixels in an LED/LCD monitor may be physically rendered incapable of activation and display.

In some embodiments of the present invention, optical character recognition algorithms utilized in the digital conversion device 35 may include artificial intelligence and machine learning methods to improve the accuracy of the capture; recognize and correct data bytes having values outside the range of the selected set of characters; warn of the possible use of steganography to obfuscate malicious code in strings of alphanumeric characters; and/or perform other functions useful for the creation, storage, and retrieval of clean digital content. To facilitate recognition of pictorial character images, the digital processor in the display driver device 15 may be programmed to display the digital content utilizing a font and format that is optimized for recognition by the optical character recognition algorithms executed by the digital conversion device 35.

In some embodiments of the present invention, additional methods may be applied in the digital processors in digital devices 10 and 35 which recognize executable code transformed into human readable pseudo content by cybercriminals using steganographic techniques to obfuscate malicious code. For example, but without limitation, the digital processors in devices 10 and 35 may utilize artificial intelligence to recognize pseudo content and embedded malicious code which use the least significant bits of ASCII values of otherwise valid characters to inject malicious code. Another example, artificial intelligence may be used to train filters to recognize and block, or warn operators of, non-sensical or otherwise grammatically incorrect words or sentences and numerical values outside an expected range.

In some embodiments of the present invention, data processing algorithms may be executed in virtual machine processing environments within the digital processors utilized in devices 10, 15, 30, 35, and other digital processors which process digital content. The virtual machines isolate the digital content, algorithms, and data on which they operate from other digital processors and data in the closed network. For example, but without limitation, all processing of pictorial images within the protected data facility 90 may occur in virtual machines utilizing hardware implemented virtualization technology and operating systems which effectively isolate virtual machines containing digital content from any and all other virtual machines containing digital data within the closed network.

In some embodiments of the present invention, the pictorial image of alphanumeric characters and/or other defined characters is communicated from the sender to the receiver across an analog air gap 80 by electromagnetic waves with frequencies outside the human visible spectrum, by light transmitted through fiber optic bundles, and/or by other mediums capable of communicating analog information.

In some embodiments of the present invention, multiple parallel input, processing, storage, and/or output devices may be employed to increase the throughput into and out of the protected data facility 90.

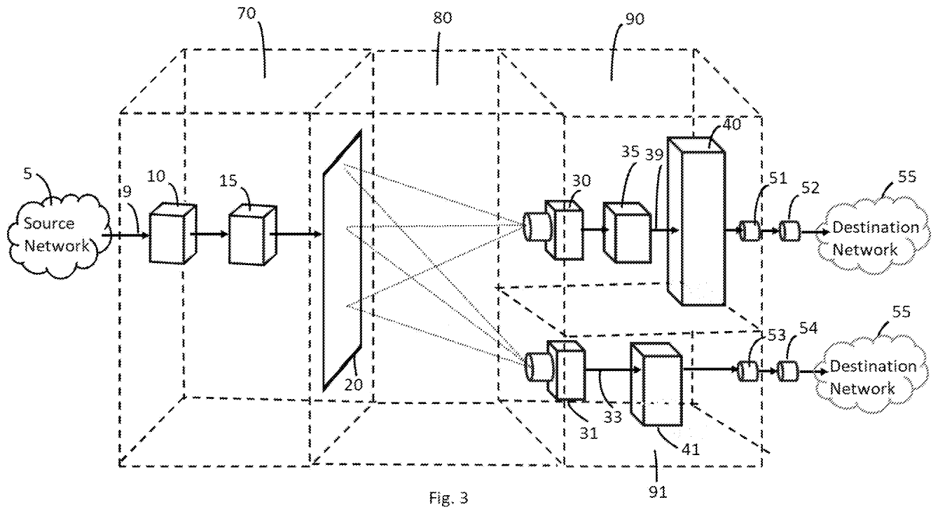

Referring to FIG. 3, in some embodiments of the present invention, a second dedicated image sensor device 31 which consists of an optical lens, one or more image sensors, and dedicated digital processors, may be utilized to capture a pictorial image of the digital content 9 in the source digital data stream including both digital content which is capable of representation as pictorial characters and pictorial information which is not capable of representation as pictorial characters. The extracted digital content 9 from source network 5 may be displayed on a monitor or other display device 20, captured as a pictorial image by the image sensor device 31, converted by the digital processor in image sensor device 31 to a pictorial digital image file 33, and stored in a second closed network storage device 41 within the protected secure data area 91. In the embodiments illustrated in FIG. 3 the second image sensor device 31 is optically focused and/or physically configured and/or programmed to capture and record the digital content displayed on the display device 20 as a pictorial image. Recording of the pictorial image is useful for preservation of digital content containing pictorial information which is not suitable for extraction and conversion into pictorial characters, for example illustrations and photographs contained in the source digital data stream. It should be appreciated that in the various embodiments of the present invention illustrated in FIGS. 3, 4, 5, and 6 the image sensor device 31 is optically focused and/or physically configured and/or electronically programmed utilizing digital image recognition and cropping algorithms, to capture selected components of the digital content and other pictorial images displayed such as pictorial character images, pictorial information, format markup language, and/or similar pictorial representations of data, similar to the manipulation of an optical camera lens to selectively photograph one or multiple views of various components of an object. In the embodiments illustrated in FIG. 3 the second image sensor device 31 captures and records the digital content which is displayed on display device 20.

In such embodiments the capture, conversion, and storage of the digital pictorial image file 34 occurs in a closed network within a designated secure data area 91 inside the protected data facility 90, which is separate and isolated from other areas within the protected data facility 90 and which meets or exceeds the isolation standards applied to the protected data facility 90. There is no physical, electronic, or other communication between the secure data area 91 and other areas within the protected data facility 90. Digital data diodes 53 and 54 and/or similar devices enforcing one way data flow are used as a method of transmission from the designated secure data area 91 to a destination network 55 outside the secure data facility.

For example, but without limitation, a document containing text, illustrations, photographs, and inked signatures may be displayed on a monitor or other display device 20, captured by an image sensor and converted to a digital image file 34 in the dedicated image sensor device 31, and stored in the second closed network storage device 41 within the secure data facility secure data area 91. Because the displayed image is a pictorial image which is captured by the image sensor and converted into the new digital image file 34 it is unlikely to be capable of containing malware. Furthermore, in some embodiments, the dedicated digital processor device in the image sensor device 31 may be programmed to perform bit operations on the digital image file 34 which preserve pictorial digital content while deconstructing any obfuscated malicious code in the image, such as an embedded QR code.

If requested by an authorized individual or entity, the clean content file 39 and digital image file 34 may be utilized to reconstruct the digital content, by applying a digital method and/or device (not shown) inside or outside the protected data facility 90 and the designated digital secure data area 91, in a format and layout closely approximating the format and layout in the source digital data stream, for example a reconstructed copy having the same illustrations, inked signatures, particular font, font size, and margins as in the source digital data stream. A warning accompanies any copy of the digital image file retrieved by an authorized individual or entity stating that the image may contain malicious code in the form of pixel patterns, and that the archival reference copy retrieved from the closed network storage device 40 should be considered to be the only version known to contain only clean digital content. The reconstructed copy may be delivered utilizing print or other similar analog pictorial medium to eliminate any digital cyberthreat vectors.

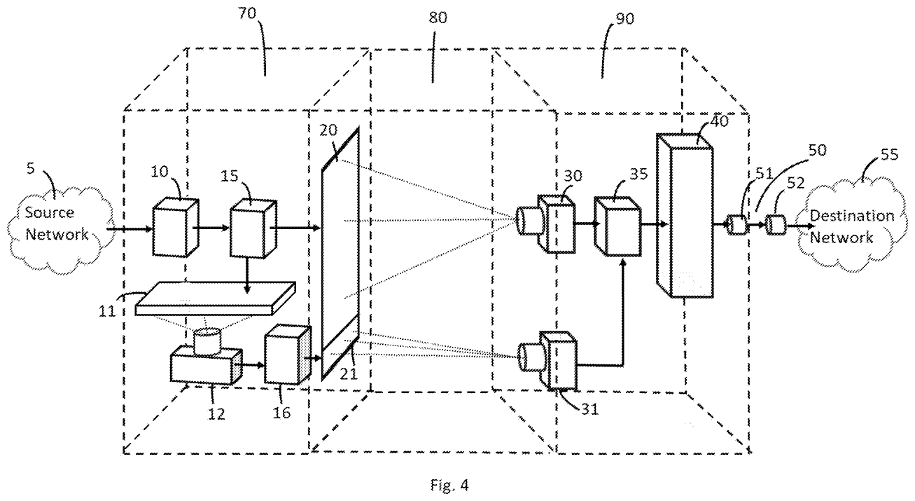

Referring to FIG. 4, in some embodiments of the present invention, the pictorial image of the digital content as originally formatted may be captured and parsed outside the protected data facility 90 in the data preparation area 70 to determine the layout of original content, which may then be recorded in a meta data format utilizing markup language (for example XML, or Rich Text Format). The meta data is constructed from an image of the original document displayed on the display device 11; captured by the image sensor device 12, which consists of an optical lens, one or more image sensors, and dedicated digital processors; and converted into a pictorial character image of the meta data by the digital processor in the display device driver 16, and is not obtained from meta data embedded in the source digital data stream from the source network 5. The pictorial image of the meta data may be displayed along with the pictorial characters generated by display driver device 15 on the display device 20 and/or displayed on a similar display device; captured by the image sensor device 31 which consists of an optical lens, one or more image sensors and dedicated digital processors; processed by the digital conversion device 35; stored in the closed network storage device 40 with the digital content consisting of pictorial characters, and, if requested by an authorized individual or entity, used to format the clean content in a format and layout closely approximating the format and layout in the source digital data stream, for example having a particular font, font size, and margins. In the embodiments illustrated in FIG. 4 the second image sensor device 31 captures and records the meta data which is displayed on the display device 20.

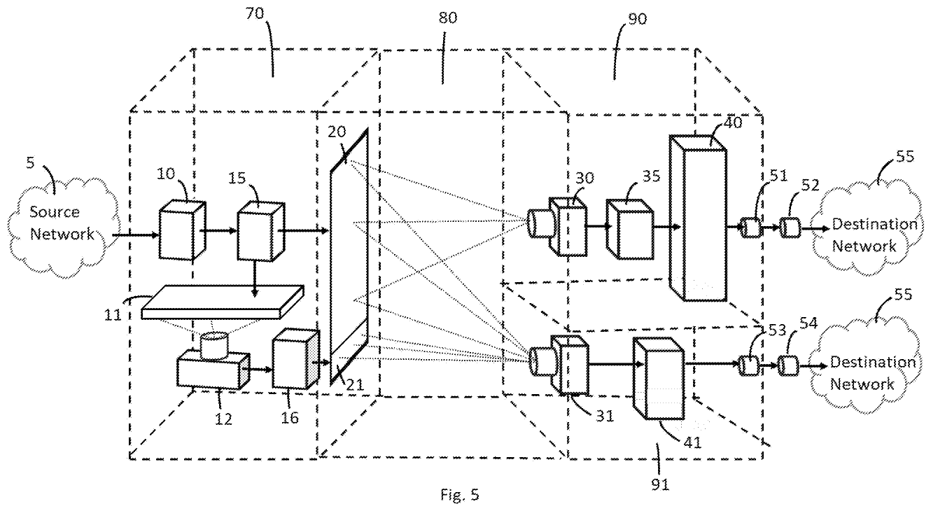

Referring to FIG. 5, in some embodiments of the present invention, the second dedicated image sensor device 31 which consists of an optical lens, one or more image sensors, and dedicated digital processors, may be utilized to capture a pictorial image of the digital content 9 in the source digital data stream including both digital content which is capable of representation as pictorial characters and pictorial information which is not capable of representation as pictorial characters. The extracted digital content 9 from source network 5 may be displayed on a the display device 20, captured as a pictorial image by the image sensor device 31, converted by the digital processor in the image sensor device 31 to the pictorial digital image file 33, and stored in the second closed network storage device 41 within the protected secure data area 91.

Furthermore, the pictorial image of the digital content as originally formatted may be captured and parsed outside the protected data facility 90 in the data preparation area 70 to determine the layout of original content, which may then be recorded in a meta data format utilizing markup language (for example XML, or Rich Text Format). The meta data is constructed from an image of the original document displayed on the display device 11; captured by the image sensor device 12, which consists of an optical lens, one or more image sensors, and dedicated digital processors; and converted into a pictorial character image of the meta data by the digital processor in the display device driver 16, and is not obtained from meta data embedded in the source digital data stream from the source network 5. In the embodiments illustrated in FIG. 5 the second image sensor device 31 captures and records the digital content and the meta data which is displayed on the display device 20.

If requested by an authorized party, the digital content file, the meta data, and the digital image file may be utilized to reconstruct the digital content, utilizing a digital process or device (not shown) inside or outside the protected data facility 90 and the designated secure data area 91, in a format and layout closely approximating the format and layout in the source digital data stream, for example having illustrations, inked signatures, particular font, font size, and margins. A warning accompanies any copy of the digital image file retrieved by an authorized individual or entity stating that the image may contain malicious code in the form of pixel patterns, and that the archival reference copy retrieved from the closed network storage device 40 should be considered to be the only version known to contain only clean digital content. The reconstructed copy may be delivered in print or other similar analog pictorial medium to eliminate any cyberthreat vectors.

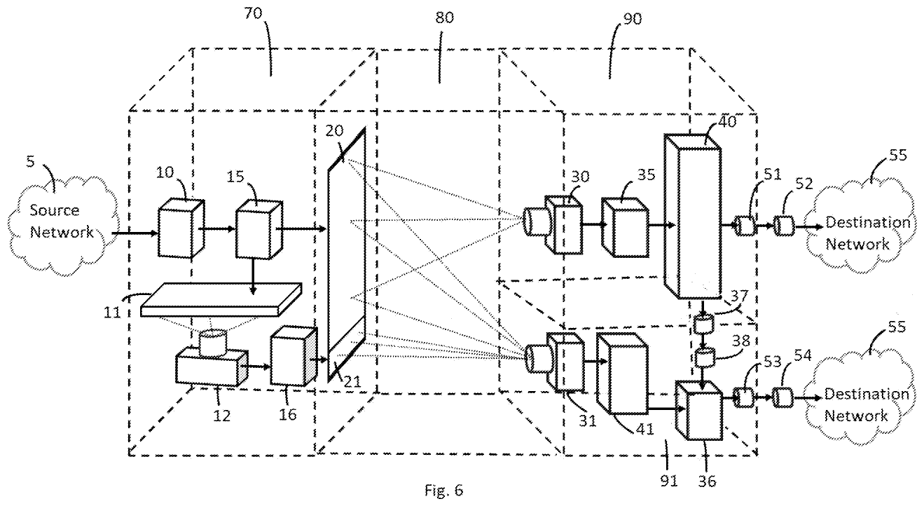

Referring to FIG. 6, in some embodiments of the present invention the digital content file, the meta data, and the digital image file may be utilized to reconstruct the digital data as illustrated in FIG. 5 inside the designated secure data area 91 by transmitting a clean digital content file from closed network storage device 40 in the protected data facility 90 across a digital air gap to the digital conversion device 35 in the designated digital image area 91 utilizing one way digital diodes 37 and 38. On request by an authorized individual or entity a copy of the archived clean content may be transmitted to a destination network 55 utilizing digital diodes 51 and 52 and/or a reconstructed copy in a format and layout closely approximating the format and layout in the source digital data stream may be transmitted to a destination network 55 utilizing digital diodes 53 and 54. A warning accompanies any copy of the digital image file retrieved by an authorized individual or entity stating that the image may contain malicious code in the form of pixel patterns, and that the archival reference copy retrieved from the closed network storage device 40 should be considered to be the only version known to contain only clean digital content. The reconstructed copy may be delivered in print or analog pictorial medium to eliminate any cyberthreat vectors. In the embodiments illustrated in FIG. 6 the second image sensor device 31 captures and records the digital content and the meta data which is displayed on the display device 20.

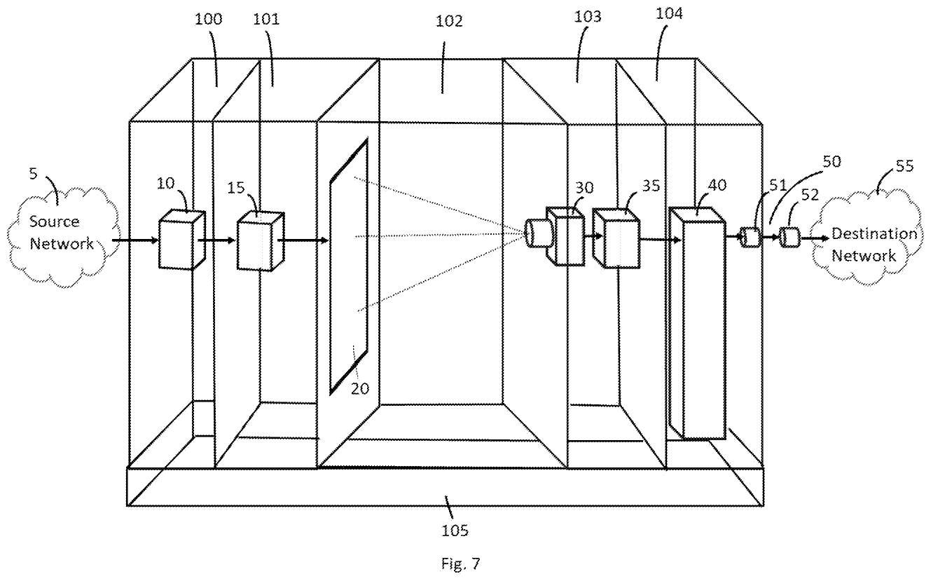

Referring to FIG. 7, in some embodiments of the present invention, the various components of the apparatus are separated into modules which may be combined in various configurations for the purpose of increasing or decreasing processing and storage capacity and speed and/or for other purposes. Each module may be removed for repair and maintenance and/or a replacement module may be installed. For example, but without limitation, a data preparation module 100 housing the digital filter device 10; a data preparation module 101 housing the display driver device 15; an air gap module 102 housing the display device 20, the analog air gap 80, and the external portal to image sensor device 30; a secure data facility processing module 103 housing the digital conversion device 35; and a secure data facility data storage module 104 housing the closed network storage device 40 and one way digital diode 51 to transmit data out of the module to digital diode 52 and destination network 55. It should be understood that all embodiments of the present invention may be separated into modules which may be combined in various configurations. It should be appreciated that one or more embodiments of the present invention may be combined and/or implemented in one or more modules such that a module and/or modules may perform more than one process, for example, but without limitation, modules 103 and 104 may contain any combination of devices 30, 31, 35, 36, 40, 41, 51, and 53 so as to be programmatically configurable to execute the embodiments illustrated in FIGS. 2, 3, 4, 5, and/or 6.

In some embodiments of the present invention, the modules may be portable and self-contained. In such embodiments a self-contained environmental module 105 is attached, usually as a base, which provides electrical isolation, cooling, physical and electronic security, and other functions required by the chosen level of security. In such configurations the entire apparatus may be designed to meet or exceed the requirements of the United States Department of Defense for certification as a Sensitive Compartmented Information Facility (as prescribed in Intelligence Community Directive 705, 705-1, 705-2, and successor regulations) regardless of the security level of the facility in which the modules are located and operated.

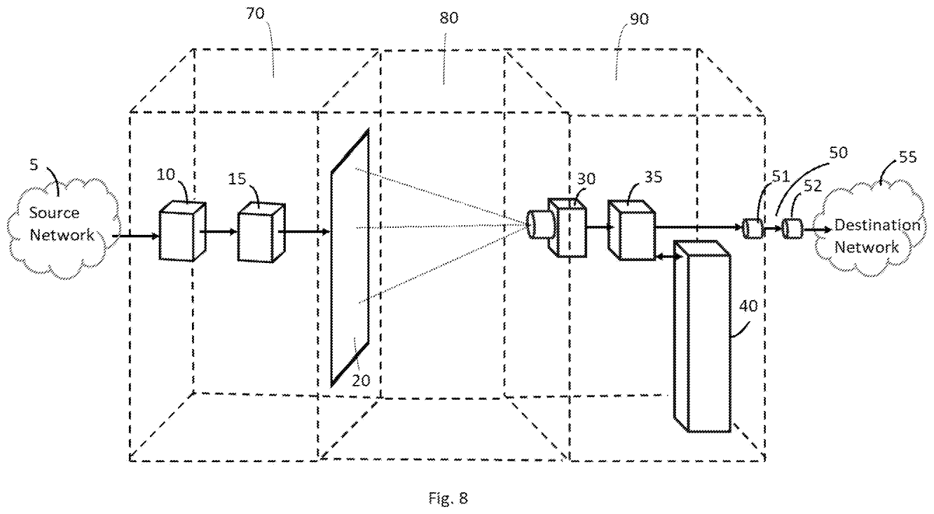

Referring to FIG. 8, in some embodiments of the present invention, the apparatus and methods of the present invention are configured as a digital filter for use in existing private closed networks to process clean content which is transmitted in real time across digital air gap 50 to a destination network 55 for real time of delayed use. An archival reference copy of the clean content may also be stored in the closed network storage device 40.

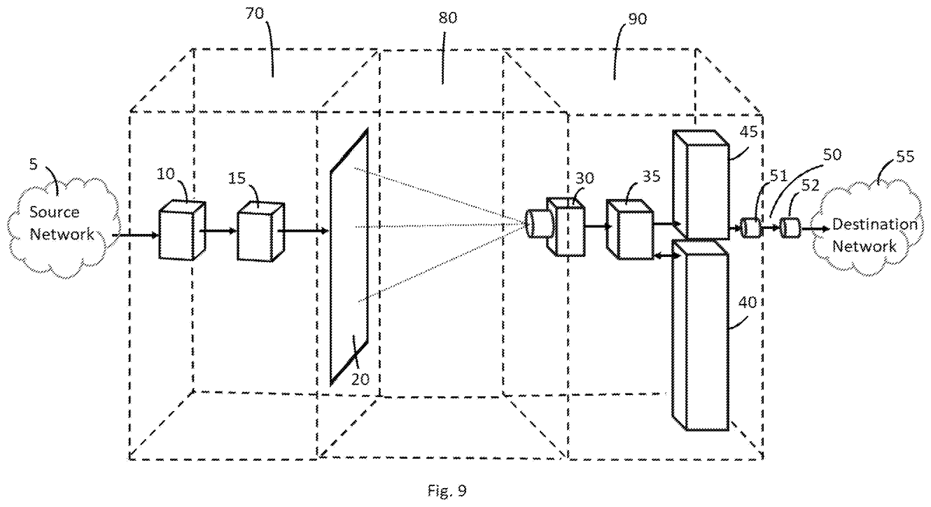

Referring to FIG. 9, in some embodiments of the present invention, a digital processing and storage device configured as a database server 45 may be present inside the protected data facility 90 and may contain copies of clean content data extracted from digital archival reference copies stored in the closed network storage device 40. For example, but without limitation, an archival copy of clean content containing personal identifiable information (PII) of individuals may be utilized to create database records containing the dates of birth of individuals. One or more authorized entities or individuals providing the PII may subscribe to the database as software as a service (SaaS) and input PII and other similar data in the source digital data stream for inclusion in the database 45.

An authorized individual or entity may make a unidirectional request for access to PII and/or other data stored in the database server 45 utilizing the same and/or similar one way apparatus and methods used to transmit clean content into the protected data facility 90. In some embodiments of the present invention, the request may be made using an application programing interface (API) which transmits the request utilizing the same and/or similar one way apparatus and methods used to transmit clean content into the secure data facility 90. The database device 45 validates and services authorized requests by real time transactional or delayed transmission across the digital diode air gap 50 to authorized entities or individuals who provided the data or are otherwise authorized to possess the requested digital content. As part of authorization to access data stored in database server 45, individuals and entities are required to provide evidence of compliance with privacy laws, regulations, policies, and best practices.

In some embodiments of the present invention, the database server and database software 45 may contain copies of PII and other data related to one individual which was submitted by more than one individual or entity. In such cases a many to one index is maintained in the database server by the database software associating more than one authorized individual or entity with a single individual's PII. The database is normalized so that there is no duplication of PII or other data. Authorized requests for copies of PII and other data from more than one authorized individual or entity are served from the single, normalized, PII data record for the individual.

Algorithms in the digital processor in the database server 45 monitor requests for retrieval of PII and other protected data and generate operator warnings and/or deny requests if the volume is abnormally high; other anomalous patterns of request are detected; and/or if a request for PII is received from an unauthorized individual or entity. The apparatus and methods of the present invention protect PII, including data subject to HIPAA (Health Insurance Portability and Accountability Act) and GDPR (General Data Protection Regulation) regulations, and significantly reduce the risk of data breaches.

The foregoing descriptions of possible implementations consistent with the present disclosure does not represent a comprehensive list of all such implementations or all variations of the implementations described. The description of some implementations should not be construed as an intent to exclude other implementations described. For example, artisans will understand the present specification as describing how to implement the disclosed embodiments in many other ways, using equivalents and alternatives that do not depart from the scope of the disclosure. Moreover, unless indicated to the contrary in the preceding description, no particular component described in the implementations is essential to the invention. It is thus intended that the embodiments disclosed in the specification be considered illustrative, with a true scope and spirit of invention as described herein.

I claim:

1. A method for one way data communication of information from an open network to a closed network across an air gap, the method comprising the steps of:
providing from a digital data stream from a source network to a digital filter located in the open network;
recognition and extraction of digital content embedded in said digital data stream;
deletion of the remaining digital data stream;
conversion of the digital content into pictorial character images;
display of the pictorial character images on the open network side of an air gap barrier;
capture of the pictorial character images by an image sensing device located on a closed network side of the air gap barrier;
conversion of the captured pictorial character images to a digital image file;
and conversion of the digital image file to a digital clean content file utilizing optical character recognition algorithms.

2. The method of claim 1 wherein the digital filter includes digital filtering, data dictionary, pattern matching, artificial intelligence, and machine learning to recognize and extract the digital content from the digital data stream.

3. The method of claim 2, including the further step of conversion of the extracted digital content into pictorial characters.

4. The method of claim 3, including the further step of parsing the pictorial characters to identify and mark for manual review or automatic deletion strings of characters which may represent obfuscated malicious code.

5. The method of claim 4, including the further step of insertion and/or deletion of characters so as to render the string of characters incapable of encoding malicious code.

6. The method of claim 5, including the further step of formatting and adjusting the resolution of the characters to optimize recognition by the character recognition algorithms.

7. The method of claim 3, including the further step of displaying the digital content on the sending side of an air gap as a pictorial character image.

8. The method of claim 5, including the further step of capturing the pictorial character image on the receiving side of an air gap.

9. The method of claim 8, including the further step of conversion of the analog pictorial image to a digital image file.

10. The method of claim 9, including the further step of parsing the digital image file to remove and/or minimize aliasing and other anomalous digital artifacts and improve the resolution of the pictorial characters in the digital image file.

11. The method of claim 9, including the further step of parsing the digital image file utilizing optical character recognition algorithms to convert the pictorial character images into a digital content file.

12. The method of claim 11, including the further step of adding an index and other utility digital code into the digital content file to facilitate storage, retrieval, security, encryption, and other similar file properties.

13. The method of claim 12, including the further step of saving said digital content file in archival storage on read only media.

14. A data communication device for one way data transmission of information from an open network to a closed network across and air gap, the device comprising:
a digital processor in at least one control device capable of receiving a digital data stream from the open network;
at least one device capable of recognition and extraction of digital content embedded in the data stream;
at least one device capable of conversion of the digital content into pictorial character images;
at least one device capable of display of the pictorial character images on the open network side of an air gap barrier;
at least one device capable of capture of the pictorial character images in a dedicated receiving device on the closed network side of the air gap barrier;
and at least one device capable of conversion of the captured pictorial character images into a digital content file;
and at least one device capable of storage of the digital content file in the closed network.

15. The devices of claim 14, further comprising one or more devices to encrypt, store, and retrieve copies of read only archived clean digital content files from the closed network.

16. The device of claim 14, further comprising a second capture device in the closed network used to record and store an unprocessed pictorial image of content in the source digital data stream which is not suited to conversion into characters.

17. The device of claim 16, further comprising a digital processor device which alters the pictorial image of the content not suited to conversion into characters to eliminate any malicious code vectors in the image while preserving the digital content in the image.

18. The device of claim 14, further comprising a second display, airgap, and capture device in the open network used to recognize the format of the digital information in the source digital data stream and encode the format using extended markup language, which is then transmitted as pictorial characters displayed on the open network and captured on the closed network.

19. The devices of claim 18, further comprising a defined digital device to utilize copies of the clean digital content files, the encoded format, and the pictorial image to reconstruct the content, format, and layout of information in the source digital data stream.

20. The devices of claim 14, further comprising one or more database servers from which authorized users can retrieve copies of archived clean digital content.
